(19) United States
(12) Patent Application Publication
(10) Pub. No.: US 2018/0322714 A1
(43) Pub. Date: Nov. 8, 2018

(54) METHODS, SYSTEMS, MOBILE DEVICES AND SOFTWARE PRODUCTS FOR AUTOMATIC DATA PROCESSING IN THE MAINTENANCE OF ENGINE OR VEHICLE SYSTEMS

(71) Applicant: Rolls-Royce Deutschland Ltd & Co KG, Blankenfelde-Mahlow (DE)

(72) Inventor: Mark GENNOTTE, Rangsdorf (DE)

(21) Appl. No.: 15/775,964

(22) PCT Filed: Nov. 10, 2016
(86) PCT No.: PCT/EP2016/077345

§ 371 Date: May 14, 2018

(30) Foreign Application Priority Data
Nov. 12, 2015 (EP) 15194315.6
Aug. 1, 2016 (EP) 16182237.4

(51) Int. Cl. G07C 5/08; G07C 5/00; G06Q 10/00; B64F 5/60

(52) U.S. Cl. CPC G07C 5/0808; G07C 5/008; G05B 19/4099; G06Q 10/20; B64F 5/60; G07C 5/085

(57) ABSTRACT

A method for automatic data processing in engine systems maintenance or manufacturing includes the following steps: scanning engine component information or vehicle component information from an information carrier coupled to an engine component or vehicle component or associated with the engine component or vehicle component with an image scanner device of a first mobile device, wherein the information carrier includes a pattern which is scanned as a scan-pattern, the scan-pattern is then compared by a pattern-matching method with prestored patterns in a database, the pattern-matching method being executed on the computer system and processing the engine component information or the vehicle component information in a computer system connected at least intermittently with the first mobile device and/or in a computer system integrated with the first mobile device, the first mobile device communicating with a central computer system through a wireless network.

This application is the National Phase of International Application PCT/EP2016/077345 filed Nov. 10, 2016 which designated the U.S.

This application claims priority to European Patent Application No. 15194315.6 filed Nov. 12, 2015 and European Patent Application No. 16182237.4 filed Aug. 1, 2016. Both of the above European applications are incorporated by reference herein.

### BACKGROUND

The invention relates to methods for automatic data processing in the manufacturing or maintenance of engine systems or vehicle systems, systems for automatic data processing in the maintenance of engine systems, a mobile device and software products.

Engine systems, in particular aircraft engines involve complex machines which are operated around the world. The term engine systems is applicable to internal combustion engines and non-internal combustion engines. Particular aircraft engine might be present in many locations within a rather short time period making it difficult to organize engine maintenance in the field. Maintenance in this context comprises the regular maintenance according to the specifications of the manufacturer as well as maintenance due to a possible or imminent failure requiring the replacement of an engine component. But the complexity of engine maintenance is not only limited to aircraft engines.

Wind engines or nuclear systems require regular maintenance which can involve high cost and/or large engine components. Nuclear engine systems, such e.g. in submarines, also require conformance with regulations.

Therefore, maintenance is broadly understood as any work required on an engine system and/or an engine component after the engine assembly was firstly completed by the manufacturer.

Manufacturing is broadly understood to comprise the steps in assembling a final engine or vehicle system from parts or sub-systems of parts. Vehicle systems comprise complex technical systems such as cars, trains or airplanes.

Known systems and methods to identify components, but not specific to aircraft engine components are described in US 2013/0211939 A1 or US 2015/0025984 A1.

### SUMMARY

Therefore methods and systems with an improved maintenance engine systems are required.

Methods for the automatic data processing in engine system maintenance or manufacturing, in particular aircraft engines, or vehicles systems maintenance or manufacturing with features as described herein are addressing this issue. One method comprises the following steps.

a) Scanning of engine component information or vehicle component information from an information carrier coupled to an engine component or a vehicle component or associated with the engine component or the vehicle component with an image scanner device of a first mobile device, in particular a smartphone or a tablet computer. The engine or vehicle component information allows the identification of an engine component which is then used in the further processing. With this information it is e.g. possible to detect, if the component is genuine, a fake, faulty or subject to a current worldwide re-call of the component. It is also possible that no flight test components or black-listed components (e.g. parts salvaged from an accident) are fitted and/or assembled into an engine or vehicle that is intended for normal operation.

The engine or vehicle component can be e.g. a single device but also an assembly (e.g. a complex engine component) comprising a plurality of parts. It is also possible to scan more than one engine or vehicle component at the same time.

b) The information carrier, in particular a QR-Code, a DataMatrix-Code or a barcode comprises a pattern which is scanned as a scan-pattern. This means that the information encoded in the information carrier is not decoded but the information carrier is taken as a pattern, i.e. a scan-pattern. This scan-pattern is then compared by a pattern-matching method with prestored patterns in a database, in particular a database stored in the cloud, the pattern-matching method being executed on the computer system. By using the information of the pattern of the information carrier itself rather than the encoded information in the information carrier allows more efficient processing if e.g. the information carrier is damaged. The scan-pattern is compared against prestored patterns e.g. from a company database or an engine component database.

Since the location and further information (e.g. engine or vehicle type) etc. can be deduced from the location of the first mobile device, it is possible in one embodiment to reduce the search space for the pattern-matching method. Therefore, the pattern-matching method can comprise a machine-learning component and/or processing means for location information of the first mobile device for speeding-up the pattern-matching. The machine learning component can use information from past requests to quickly classify a present request. The classification result can then result in a faster search and comparison with the prestored patterns.

c) Processing the engine component information or vehicle component information in a computer system connected at least intermittently with the first mobile device and/or in a computer system integrated with the first mobile device. The scanned information regarding the engine or vehicle component is then further processed by the computer system. The computer system can be integrated with the first mobile device and/or it can be accessed via a data transfer line, e.g. a wireless data connection which can be established from a smartphone. In the latter case, the first mobile device would not always be connected to the computer system. It is also possible that different parts of the data processing are executed by different parts of the computer system which can also include cloud components.

The first mobile device is communicating with a central computer system through a wireless network, in particular comprising the internet, (e.g. the first mobile device (smart device) is connected via internet via to cloud based data base. The cloud based data base is e.g. connected to company server).

Another method comprises the following steps:

a) Scanning of engine component information or vehicle component information (I) from an information carrier coupled to an engine component or vehicle component with an image scanner device of a mobile device, in particular a smartphone or a tablet computer. The engine or vehicle component information allows the identification of an engine or vehicle component which is then used in the further processing. The engine or vehicle component can be e.g. a single device but also an assembly (e.g. a complex engine component) comprising a plurality of parts. It is also possible to scan more than one engine or vehicle component at the same time.
b) Processing the engine component information or vehicle component information in a computer system connected at least intermittently with the mobile device and/or in a computer system integrated with the mobile device. The scanned information regarding the engine or vehicle component is then further processed by the computer system. The computer system can be integrated with the mobile device and/or it can be accessed via a data transfer line, e.g. a wireless data connection which can be established from a smartphone. In the latter case, the mobile device would not always be connected to the computer system. It is also possible that different parts of the data processing are executed by different parts of the computer system which can also include cloud components.
c) The engine component information or vehicle component information is processed in the computer system automatically generating at least one event in dependence of the engine or vehicle component information. In particular, an order event for the engine or vehicle component is generated. The event comprises e.g. a dataset which defines a task which is supposed to be executed (in particularly automatic) by the recipient of the event dataset. One example for an event would be an order for a replacement component for the engine component. Other examples could be the automated generation of return labels, the automated generation of warranty requests and/or the automated generation of purchase orders.
d) Then, the computer system automatically sends an information token to the mobile device in dependence of the generation of the at least one event, in particular a confirmation token of the at least one order event. Upon receiving the token, the user of the mobile device, e.g. an engine mechanic, knows that the request was processed.

In the following some examples for the methods are given.

1) As soon as match for the pattern is found, an end user can be provided with a 3D movie on how part is to be removed and installed.
2) As soon as match for the pattern is found, previous damage assessment can be over-layed on current damage finding and immediate accurate damage progression mapping can be performed.
3) As soon as match for the pattern is found, dimensional data is known so augmented reality can be applied. The Smart device now knows where other components are situated in relationship to scanned component.
4) As soon as match for the pattern is found, information provided to end-user is tailored in such a way that it shows only what physically and legally can be fitted to an engine i.e. what service bulletins or modification standard of parts are allowed to be fitted. What other complementary modification parts have to be fitted in addition if alternative modification part is installed.
5) Information supplied to end user takes into account which engine the part initially originates from—either from a left or right hand configuration—Some engine parts are handed depending if it is a left or right hand installation on aircraft.
6) Information supplied to end user is smart, e.g. if technician wants to remove an installed component, technician will be pre-warned if subject component was only recently installed (e.g. some two weeks prior) and that unit is unlikely to have failed in such short time span.
7) Information supplied to end user can state if the “serviceable used” replacement part which has to be installed, requires a minimum release life in order to meet the next scheduled overhaul/refurbishment interval.

The engine component information or the vehicle component information is processed in the computer system automatically generating in one embodiment at least one event in dependence of the engine or vehicle component information. In particular, an order event for the engine or vehicle component is generated. The event comprises e.g. a dataset which defines a task which is supposed to be executed (in particularly automatic) by the recipient of the event dataset. One example for an event would be an order for a replacement component for the engine or vehicle component. Other examples could be the automated generation of return labels, the automated generation of warranty requests and/or the automated generation of purchase orders.

In one embodiment of the methods a central computer system checks upon receiving the event the availability of the engine or vehicle component and automatically sends availability and/or tracking data to the computer system and/or the first mobile device. For the initiator of the event, i.e. the user of the first mobile device, it is important to know if and when the engine or vehicle component will be available. By providing and processing availability and/or tracking data it is e.g. possible to generate a baseline for component supplier performance and also to assess the performance suppliers.

In a further embodiment, the central computer system automatically generates and/or sends maintenance data to the computer system and/or the first mobile device, in particular about at least one engine or vehicle component which might require replacement within a predetermined time period in the future. The maintenance data can be provided within the method for engine or vehicle components in general, i.e. also for engine or vehicle parts which are not coupled with an event. It is e.g. possible that the central computer system will recommend that not only the requested engine or vehicle component is replaced but other, technically related engine or vehicle components as well. The central computer system can e.g. take into account the maintenance history of the engine or vehicle, so it can predict, when the next maintenance will be due. It might be more economical to replace a number of components in one instance than to replace the components at different times. It is also possible that regulatory requirements (e.g. for nuclear systems or aircraft engines) require the replacement of certain components. The databases of the central computer system can provide this information so that upcoming replacements required by regulations can be made at an earlier time when some other part is already about to be replaced. This way it is possible to reduce maintenance costs by lumping together maintenance tasks.

The availability and/or tracking data and/or the maintenance data can, in one embodiment, automatically be generated in dependence of the geographic location of the first mobile device. Due to the communication process it is generally known from which location the request (i.e. the event) is generated. Information, e.g. from manuals, can be provided in suitable language for the location. The information can be displayed e.g. on the smartphone or the tablet computer. Dependent on the location or a preferred setting in the computer system and/or central computer system, some or all information will be displayed in a preset (e.g. preferred) language. The manual can e.g. include graphical information in 3D about the engine or vehicle component making it easier to execute the maintenance job. Due to the scanning of the component information the computer systems automatically know which part of the manual might be most useful in a particular maintenance situation.

It is also possible that information related to the event is automatically forwarded to a fleet management, a regulatory system, engine health monitoring system, a component health monitoring system, a billing system and/or statistically processed in the central computer system. Through this embodiment of the methods, a large amount of engine and/or component data is gathered over time. This data can form part of an input or vehicle to a fleet management, engine health monitoring and/or vehicle health system. The first system is e.g. used to assess the maintenance schedule of a plurality of engines or vehicles in the fleet of an operator.

For example, live engine health management data can be supplied to cloud, especially transmission of 1 Hz data provides a manufacturer with the ability to supply an end user app with actual running times on each component but also the health level. For example knowing exactly how long a valve requires to close, provides an indication if a failure of the valve is imminent or not. An app which can scan e.g. a QR/Data matrix code on a component can then immediately provide a “health status”.

The second system can be used to manage the schedule of individual engines or vehicles. A coupling with the billing system simplifies the commercial handling of orders. Warranty information, fleet behavior, audit information, environmental information (e.g. temperature, humidity, air pressure), quality control information and/or supply chain information can automatically be included. Since complex engine or vehicle systems are increasingly subject to regulation, the event might also trigger an information to a regulatory systems. This would then be informed that certain components are worked upon or are being replaced. Over time the regulatory system can gather information about the regulated engine or vehicle systems so that statistic and safety analysis would be available. These systems can be used individually or in combination.

The methods can use information carrier comprising a two-dimensional code, in particular a QR-Code or DataMatrix-Code, a RFID-transponder and/or a barcode. All these markings can be used to identify engine or vehicle components.

To accelerate the process, the event automatically triggers the printing of a transport label for transporting the engine or vehicle component to a predetermined location and/or automatically triggers a transport order of the engine or vehicle component to a predetermined location, in particular in dependence of a cost and/or route optimizer. Since the component information already comprises or points to the relevant information, the automatic label creation does help in shipping an engine or vehicle component. Since a logistics service provider can have access to this data, the material handling process will be simplified.

In a further embodiment the at least one event automatically triggers at least one process in the supply chain management for the engine or vehicle component and/or a statistical analysis. The term supply chain has to be understood in a broad way involving all possible steps in providing engine or vehicle components. The scanned engine or vehicle component information can be used with other technical and/or commercial data available on the central computer system, in particular by gathering the technical and/or commercial data at least in part through the scanning of the engine or vehicle component data. The first mobile device and the scanning are therefore means for generating a database which can be used in many ways (e.g. auditing of regulatory requirements, safety analysis, economic performance analysis etc.)

Furthermore, it is possible that the event automatically triggers an entry in a logbook of the engine system, in particular an aircraft and/or the aircraft engine, in particular with details about a defective engine component and/or a replaced engine component. The logbook can be an electronic version stored on a computer and/or a cloud based logbook.

In another embodiment of the methods the engine or vehicle component information is associated with code data which can only be processed by an authorized scanner device and/or first mobile device. The code data can e.g. only be decrypted by first mobile devices running a program (in particular an App) which is authorized by the respective engine or vehicle manufacturer. Only customers under contract e.g. with a manufacturer will be able to obtain e.g. Apps and are able to decode scanned data.

It is also possible that the engine or vehicle component information is associated with a 3D-printing dataset and the generated at least one event automatically triggers a 3D-printing process. The engine or vehicle component information might e.g. comprise a link to a database with 3D-printing data files. Those data files can be forwarded to a 3D-printer to print the component (or related tool for the component) which has been scanned in the engine or vehicle. The printing could take place on site or remotely, so that the at least one event would also trigger the transport of the printed component. Given the range of available polymer and metal printing material, a wide range of engine or vehicle parts could be printed.

In one embodiment at least one first mobile device and at least one second mobile device, the at least one second mobile device being coupled to a logistic person or process communicate via a wireless network, in particular comprising the internet. Therefore, the method allows an integrated communication between e.g. mechanics with a first mobile device and logistic persons with a second mobile device. When both used e.g. smartphones the communication is simplified.

In one embodiment, it is tried to decode the information carrier in at well-known way. If—e.g. through damage or corrosion—the information carrier is not legible for decoding purposes, the pattern-matching method is used, in particularly automatically after a decoding of the information carrier is not successful.

In another embodiment the pattern-matching method and the decoding of the information carrier are done concurrently which provides an extra safety check.

It is also possible that the scan of the information carrier taken from a photo, such as e.g. a manual.

In a further embodiment, the central computer system is connected to the network of the first mobile device through a http Listener continuously searching the network for messages sent by the first mobile device and/or the computer system automatically sending at least one an information token to the first mobile device in dependence of the generation of the at least one event, in particular at least one confirmation token of the at least one order event.

A system for automatic data processing in engine maintenance or manufacturing, in particular aircraft maintenance or manufacturing or vehicle maintenance or manufacturing, comprises the following devices:

a) A first mobile device, in particular a smartphone or a tablet computer, with a scanner device for scanning engine or vehicle component information from an information carrier coupled to an engine or vehicle component or associated with the engine component, with the information carrier, in particular a QR-Code, a DataMatrix-Code or a barcode comprises a pattern which is scannable as a scan-pattern by a scanner, the scan-pattern is comparable by a pattern-matching method with prestored patterns in a database, in particular a database stored in a cloud server, the pattern-matching method being executed on the computer system.
b) A computer system for processing the engine or vehicle component information, the computer system connectable at least intermittently with the first mobile device and/or integrated with the first mobile device, the first mobile device communicating with a central computer system through a wireless network, in particular comprising the internet.

One embodiment comprises an event generation unit for automatically generating at least one event, in particular at least one order event for the engine or vehicle component in dependence of the processing of the engine or vehicle component information. Another embodiment comprises in addition or alternatively an information token generation unit for generating an information token about the event to be sent to the first mobile device, in particular as a confirmation of the order event.

A system for automatic data processing in engine maintenance or manufacturing, in particular aircraft maintenance or manufacturing or vehicle maintenance or manufacturing, comprises the following devices:

a) A mobile device, in particular a smartphone or a tablet computer, with a scanner device for scanning engine component information or vehicle component information from an information carrier coupled to an engine component or vehicle component.
b) A computer system for processing the engine component information or vehicle component information, the computer system connectable at least intermittently with the mobile device and/or integrated with the mobile device.
c) An event generation unit for automatically generating an event, in particular an order event for the engine component or vehicle component in dependence of processing the engine component information or vehicle component information.
d) An information token generation unit for generating an information token about the event to be sent to the mobile device, in particular as a confirmation of the order event.

An embodiment of the systems comprises a first mobile device with a GPS unit for geographically locating the first mobile device.

In a further embodiment a central computer system which can be coupled to the first mobile device is coupled with a database handling maintenance data, a fleet management and/or engine health monitoring system, a vehicle health monitoring system, a regulatory system, a billing system and/or a database for statistical data processing related to events. Due to the gathering of engine or vehicle maintenance related events, the system gathers a large amount of data which allows the assessment of the maintenance process but also the status of individual engines or vehicles and fleets of engines or vehicles.

In one embodiment the scanner device and/or the first mobile device comprise a decoding unit to decode code data associated with the engine component information. This assures that only a pre-approved scanner can scan and further process the data obtained from an engine or vehicle component.

The issues are also addressed by a software product storable and operable a first mobile device with features as described herein. When in operation the software product performs the following steps for an automatic data processing in engine systems maintenance or manufacturing, in particular aircraft engine maintenance, or vehicle maintenance or manufacturing:

a) scanning engine component information or vehicle component information from an information carrier coupled to an engine component or a vehicle component or associated with the engine component or the vehicle component with an image scanner device of the first mobile device, in particular a smartphone or a tablet computer,
b) the information carrier, in particular a QR-Code, a DataMatrix-Code or a barcode comprising a pattern which is scanned as a scan-pattern, the scan-pattern is then compared by a pattern-matching method with prestored patterns in a database, in particular a database stored in a cloud server, the pattern-matching method being executed on the computer system and
c) processing the engine component information or the vehicle component information in a computer system connected at least intermittently with the first mobile device and/or in a computer system integrated with the first mobile device, the first mobile device communicating with a central computer system through a wireless network in particular the internet.

### BRIEF DESCRIPTION OF THE DRAWINGS

Embodiments of the invention are shown in the figures, where:

FIG. 1 shows a schematic view of an embodiment of a method and system for data processing in the maintenance of aircraft engines;

FIG. 1A shows the embodiment of FIG. 1 together with a second mobile device;

FIG. 2 shows a variation the embodiment shown in FIG. 1;

FIG. 3 shows a variation of the embodiment shown in FIG. 1 in which the first mobile device and the computer system are integrated;

FIG. 4 shows an overview of a system involving a cloud storage;

FIG. 5 shows an embodiment of the method in which a pattern is scanned and compared against prestored scanned images involving the cloud storage;

FIG. 6 shows a particular example of the method according to FIG. 5;

FIG. 7 shows a schematic overview of a logistic app working together an app on the first mobile device;

FIG. 8 shows an example of the functionality of the logistic app;

FIG. 9 shows an example for the communication between two apps;

FIG. 10 shows an overview of the general concept including the pattern recognition.

### DETAILED DESCRIPTION

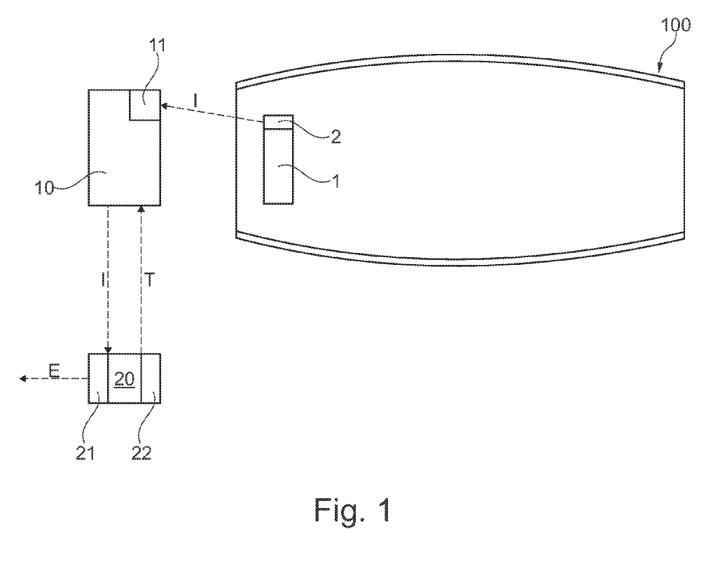

In FIG. 1 an embodiment of the method and the system for data processing in aircraft maintenance is described. An aircraft engine 100 is just one example of an engine system which can be handled by embodiments of the method and embodiments of the data processing systems. An engine system as described herein is a technical system or a machine which requires maintenance. Some exemplary embodiments other than aircraft engines 100 will be described below.

The current description assumes that an aircraft engine 100 is somewhere subjected to a maintenance process, e.g. because one engine component 1 needs to be replaced under the normal maintenance schedule or because it needs to be replaced because of some malfunction or imminent and/or predicted malfunction.

The embodiment of the method comprises four steps to which further optional steps or features can be added.

In a first step, engine component information I on an information carrier 2 is scanned with scanner device 11. The information carrier 2 is coupled to the aircraft engine component 1 (e.g. a pump, a valve, a blade, a vane, a screw, a bolt, an electronic part etc.). This means that the information carrier 2 can e.g. be physically attached or engraved (e.g. by laser marking) with the engine component 1. But it is also possible that the engine component 1 is coupled with the information carrier 2 through a list, e.g. a printed list. The information carrier (e.g. a QR-Code) can be listed and scanned, so that the engine component 1 is logically coupled with the information carrier 2. In any case the information carrier 2 provides e.g. a part number or some other identification of the engine component 1. The engine component 1 can be one individual piece of equipment or a complex assembly comprising a plurality of equipment parts.

The information carrier 2 can e.g. be a two-dimensional code such as a QR-Code or a data matrix code. In other embodiments a RFID tag or a one dimensional code such as a barcode can be used. The information carrier 2 can be attached by any means to the engine component 1. In particular, a sticker, date plate, an etched marking or a laser marking can be used as information carrier 2.

The information carrier data 2 can also be printed on accompanying paperwork or it can be displayed in an electronic logbook. This is in particular important on legacy products which do not have any QR/Data matrix code. The printing of the information carrier data 2 on paper or in the logbook are examples how the information carrier 2 can be coupled to an aircraft engine component 1 without being physical present on the aircraft engine component 1 itself.

The scanner device 11 is coupled to a first mobile device 10, in particular a smartphone 10 or a tablet computer 10. A smartphone 10 or a tablet computer 10 is understood to have a display for providing information to the user, a communication unit, an input device (e.g. keyboard), a camera, a memory for data and/or software and a built-in data processing device which can work with the data and the software. In case of the smartphone 10 or tablet computer 10, the scanner device 11 can be the camera which is built into the smartphone 10 or the tablet computer 10. It is generally known that smartphones and tablet computers 10 can e.g. scan and process QR-Codes with software stored on the smartphones 10 or tablet computers. If e.g. no smartphone 10 is used, a dedicated first mobile device 10 for scanning and processing the information carrier 2 can be used, e.g. scanners as commonly used in warehouses, overhaul/repair shops to book in parts.

It should be noted that the principle of scanning a component and being able to directly retrieve or upload data on the component record in the cloud database can also be used within a shop floor environment where the technicians or factory workers only have access to conventional 2D hand scanners.

In a shop floor example where this technology is applied the shop floor workers need to be able to track accurately where engine components and tooling are within the factory.

As using the GPS co-ordinates, generated by the smart communication device, are not accurate enough to determine where engine components or tooling is physically held (i.e. where is it stored in the exact location of a factory, shelving, rack), one would actually not only label the engine or vehicle component or tool but also the various factory locations (inspection area, wash area, assembly area, shelving, racks etc).

In this set up, factory workers using hand scanners will be able to positively track engine components or tooling.

One embodiment can be that at the various locations within the factory, each designated area, a conventional desktop PC will be installed (on which normal browser version of app is installed) which in turn is connected to a hand scanner.

The process a factory worker would then follow is:

1) scan a component/tooling
2) scan a transportation trolley, transportation crate/box
3) scan the label of the respective area.

Each time the component/tooling is moved to a different location, the item and location it was left at will be scanned again. Using this method, an accurate positive location ability is created without the use of GPS coordinates.

The data matrix and QR (2D coding) product labelling code has become the most commonly used within the aircraft engine business. It has various applications within the industry: e.g. product tracking, item identification, time tracking, document management, general marketing, consumer advertising and much more. The QR coding has become very popular due to its fast readability and greater data storage capacity compared to the standard UPC (conventional) barcodes. Within the aviation industry the usage of Data Matrix (also known as dot matrix) is currently the standard. An aircraft engine 100 manufacturer might use this coding on its engine components 1 and prescribes QR coding on packaging. The Data Matrix coding, although of an older generation, compared to QR coding, has distinct advantages when viewed against wear and tear resilience on engine components.

By capitalizing e.g. on today's modern day smartphone technology (scanning capability and apps), an aircraft engine manufacturer can capture the data at the source (in-service) on its engine components 1 as the current smartphone 10 or tablet computer 10 scanning capability can decode e.g. both Data Matrix and QR coding. Scanning the unique labelling code on each aircraft engine component 1 (or material logically coupled with it) means that a raft of information can either be provided or captured depending on what app is being used by the end consumer. This type of technology allows the engine manufacturer to capture live data each time an engine component 1 is handled—i.e. either through purchasing, shipping, inspection, tracking, removal and installation etc.

The apps which can be used in various embodiments are downloadable (e.g. through a mobile network or the internet) to respective mobile devices 10, 20. Those apps can give access to asset monitoring, diagnostics, management and/or optimization tools. Through the apps billing and stock location databases for aircraft engine components 1, searchable databases for aircraft engine components 1, tools for data collection and/or tools for inventory management can be made accessible.

Each end user with a first mobile device 10 will have a different app personalized to him/her to scan the aircraft engine component information I. The personalization allows e.g. that data is displayed or actions are suggested based on the personalization. Only individuals authorized by the manufacturer of the aircraft engine component 1 (e.g. after specialized training) will be issued with that app. This allows among other things that the certifications of responsible mechanics can be monitored. With a camera in the first mobile device the maintenance job can be documented.

Being able to capture all such activities on a 24/7 basis generates Big Data (and stored in a cloud based data base) from which it is possible to dramatically improve the efficiency across all its sectors of the supplier of the aircraft engine component 1 due to the fact that immediate capture of the “real time” data entry points can be evaluated. This in turn allows a very efficient control, steering and/or adjusting mechanism to be instated.

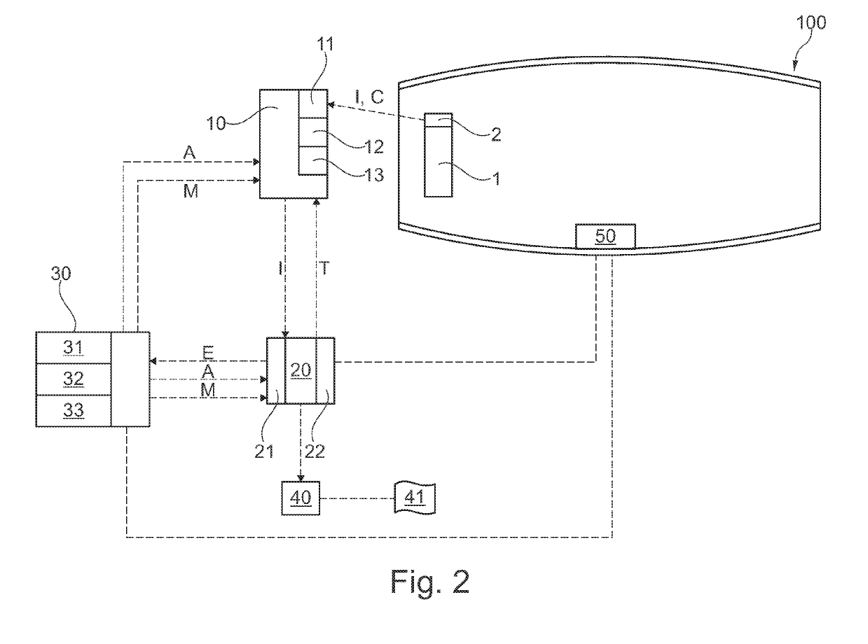

In a second step, the engine component information I is processed by a computer system 20 which is connected at least intermittently with the first mobile device 10 and/or in a computer system 20 integrated with the first mobile device 10. The computing system 20 is e.g. required to further process the engine component information I. In the embodiment shown in FIG. 1 the computer system 20 is a separate entity from the first mobile device 10 and it is accessed through a wireless data transfer connection. In the embodiment described in FIG. 3 the computer system 20 is integrated with the first mobile device 10.

In a third step, the computer system 20 identifies that the engine component 1 has actually been scanned based on the engine component information I and the computer system 20 automatically generates an event E in dependence of the engine component information I, in particular an order event E for the engine component 1. The event E can e.g. comprise some dataset comprising the identification of the engine component 1 itself, the number of replacement components, information if the engine component 1 was recently replaced (this having an impact on “No Fault Found” cases), information about the first mobile device 10 and/or its user and/or location information about the engine component 1. This information can e.g. be used in an order event E, i.e. a notice to a supplier such as the engine manufacturer. The order event E can comprise also information about the planned recipient of the order and the location where the order should be shipped to.

In a fourth step, the computer system 20 automatically sends an information token T to the first mobile device 10 in dependence of the generation of the event E, in particular a confirmation token T of an order event E. This information token T might comprise some information about the estimated time of arrival of the engine component 1 at the requested location. The user of the first mobile device 10 receives a feedback that the event E has been successfully generated and sent.

FIG. 1 also describes a data processing system for aircraft engine maintenance data comprising the first mobile device 10, in particular a smartphone or a tablet computer and the computer system 20. The computer system 20 comprises an event generation unit 21 for automatically generating the event E for the engine component 1 in dependence of the processing of the engine component information I.

Furthermore, the computer system 20 comprises an information token generation unit 22 for generating the information token T about the event E to be sent to the first mobile device 10, in particular as a confirmation of the order event E.

The embodiment of the method and system has been described in context of one engine component 1 for sake of simplicity. It should be understood that the method and the system can be used for a plurality of engine components 1 at the same time. Often, maintenance jobs require the replacement and ordering of more than one engine component 1 at the same time. In this case, more than one event E will be generated to initiate e.g. an ordering process of the engine component. It is also possible that more than one first mobile device 10 is used on one particular engine 100. In this case, the generation of the event E can be personalized to specific mechanics working on different parts of the engine 100. The data processing method and system described helps in simplifying complex maintenance jobs.

In FIG. 1A a modification of the embodiment shown in FIG. 1 is shown. Here a second mobile device 15 is connected to the first mobile device 10 through a wireless network 35, which can comprise the internet. When the mobile devices 10, 15 are e.g. smartphones the users can communicate efficiently. A mechanic as a user of a first mobile device 10 can e.g. contact a logistic person with a second mobile device 15. The second mobile device 15 can also communicate with the computer system 20 and/or the central computer system 30.

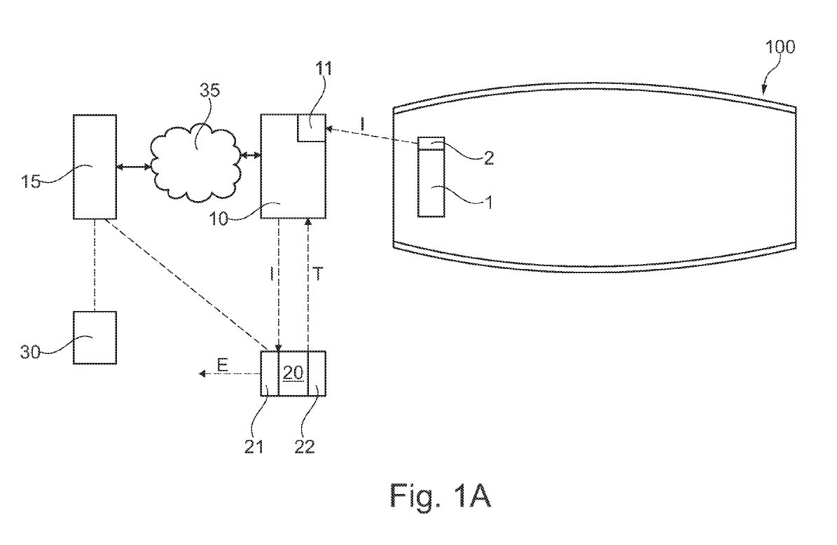

In FIG. 2 some further processing steps of the event E and implementations of the system are described. The embodiment shown in FIG. 2 is based on the embodiment described above in connection with FIGS. 1 and 1A so that reference to the relevant description can be made.

After scanning the engine component information I with the first mobile device 10, the computer system 20 can access a printer 40 to automatically print out a label 41 for a logistic service provider in case the engine component 1 needs to be returned e.g. to the manufacturer. It is also possible that the computer 20 system automatically notifies the logistic service provider about the transport request so that the part to be replaced will be automatically picked up at the location specified by the computer system 20. The logistic process can comprise
Details of accompanying paperwork (e.g. JAR Form 1 & 8130 certificates)
Material details (e.g. export control requirements)
Weights and dimensions of the aircraft engine components 1
Manufacturing code (e.g. with export control requirements)
Customers ship to and pick up address details
Customs declaration documents
Live physical tracking data
Displaying data of ship to addresses of pre-determined warehouse locations

This might also be applicable in the managing of a worldwide component stock worldwide. Using the described system will mean that the end user will be able to identify very accurately where replacement components can be obtained from—this includes the components which are rolling too (i.e. on the road with any logistics provider)—in addition, the end user could actually check whether the required component is contained within a given engine/assembly. The e.g. allows the end user to extract the required part from another engine/assembly (even from another engine mark). In practical terms, the end user scans the data plate of any engine and can be told if the engine/assembly contains the required component or not.

The event E, e.g. a dataset or a string, can be received by a central computer system 30 which can be located far away from the location of the aircraft engine 100. This can e.g. be a computer system of a supplier or the manufacturer of the aircraft engine 100.

The central computer system 30 checks the availability of the engine component 1 and automatically sends availability and/or tracking data A to the computer system 20 and/or the first mobile device 10. In particular, if the first mobile device 10 is a smartphone the communication can directly be between the central computer 30 and the smartphone 10. In FIG. 2 both possibilities are shown. With this information the user of the first mobile device 10 is informed about the status of the delivery of the engine component 1.

It is also possible that the central computer system 30 provides some maintenance data M to the first mobile device 10 directly and/or via the computer system 20 coupled to the first mobile device 10. The maintenance data M can e.g. comprise data from a manual which can show how to replace the engine component 1. This allows the full integration of manuals in an ergonomic fashion, i.e. end user is given correct information at the right time in the right format. This includes e.g. the visualization of a maintenance procedure in a 3D video.

It can also comprise warranty data. Since the event E identifies an engine component 1 the central computer system 30 can automatically determine the warranty status of the engine component 1 which might influence the billing status for that engine component 1.

In the following examples are given how the scanned aircraft engine component information I (or information derived thereof) can be used by the computer system 20 and/or the central computer system 30.
In addition or alternatively to the warranty data other product information can be processed and in some instances be made available to the user of the first mobile device 10, in particular the user of a smartphone or tablet computer.
Information about the behavior of a fleet of aircraft engines 100 and/or a fleet of aircrafts can be derived from the scanned aircraft engine component information I. This data comprises e.g. the frequency how many times an engine component 1 has been removed and/or installed. This provides an instant feedback on reliability trend monitoring and provides data for fleet management. The hours spent on maintenance and/or maintenance cycles can be centrally logged and analyzed since the scanning can be used to indicate the start and end of a maintenance job. This information can be used to automatically generate key performance indices (KPI). It is also possible to use this information for statistical analysis (e.g. automatic generation of Weibull distribution graphs) in real time or at a later time. This includes also quality control data and/or the live tracking as to where aircraft engines 100 are operating, which aircraft engine 100 has been operated on in the past. The central computer system 30 will have the full curriculum of the aircraft engine 100 and its current and past owners.
The information obtained by scanning aircraft engine component information I allows the automatic tracking of the physical components 1 (replaced and/or new ones). The data can be used to measure the performance of suppliers.
The aircraft engine component information I can be used in an audit process, in e.g. assessing the performance of an operator in troubleshooting and/or the removal of the aircraft engine component 1. It can e.g. be determined which maintenance teams are removing aircraft engine components 1 at a higher rate than others at which airports. This could identify training opportunities for maintenance crews. This information allows an assessment of the overhaul process and/or the quality control process. The aircraft engine component information I provides also an immediate insight to previous damage write ups, modifications incorporated, repairs records concessions, refurbishment intervals, and workscope details. The systematic analysis of the gathered data helps in identifying issue apart from a particular replacement component, so that a better maintenance of the engine can be recommended.
Since geographical information is instantly available due to the scanning of the aircraft engine component information I with the first mobile device, further information might be gained by processing data related to weather and/or climatic conditions. When e.g. an aircraft engine 100 is predominantly operated in a dusty or humid environment, the system on the central computer system 30 knows about the conditions a certain aircraft engine component 1 has been operated. This can automatically influence the choice of a replacement engine component 1 which is particularly suited for that particular weather and/or the particular climate conditions.
The aircraft engine component information I can provide data for the managing of the supply chain. So the times for reacting to requests, the punctuality of the service, in particular of deliveries, the conformance to contractual conditions, the automatic determination of contractual penalties or reimbursements can be determined and automatically used e.g. in the billing or supply chain management. The management of the supply chain might also include an automated and/or real time data input for the planning of spares based on scanned aircraft engine component information I. Parts more likely can be held in lager stock. The stock holding can also be influenced by projections about likely component failures so that the components will be available when the failure actually happens. This might include Line Replaceable Units.
Sales campaign information can be displayed, which can e.g. provide reduced purchase prices, should an operator order a replacement component for sister engine in addition etc. The pricing information generated and forwarded to the customer can be directly linked to the available supplies of that component.
The mechanic in the field can launch some kind distress code if some aspect of the maintenance is not going according to plan. This enables the manufacturer to take appropriate steps.

All those listed items which can be applied individually or in combination, relate to the combination of the scanned aircraft engine component information I with other technical and/or commercial data available the central computer system 30. These are all processes (individually or in combination) which can be part of the supply chain of the aircraft engine component 1.

Mutatis mutandi those items can also be applicable to other engine systems 100 such as naval systems such as ship diesel engines, nuclear engines for ships or submarines, naval machinery (e.g. anchor winches and cranes), naval transmission systems (e.g. propellers, propulsion systems, bow thrusters). Non-naval engine systems can e.g. be a combustion engine, a wind power engine or a nuclear reactor. All these systems require maintenance and the replacement of engine components.

This technical and/or commercial data is in part gathered through the scanning of the aircraft engine component data I in the field. The combination of data, seemingly unrelated (e.g. maintenance frequencies, locations, weather conditions etc.) enables the automatic generation of actionable information for the maintainer of the central computer system 30 and/or the user of the first mobile device 10.

Since smartphones or tablet computers 10 have built-in cameras the maintenance process can be enhanced for mechanics working in the field on an engine 100. In case there are questions, the engine component 1 can be identified visually (still photo, video, 3D technical publications) and the information can be relayed to a service person who can identify the relevant engine component 1 through the scanned component information I. Since smartphones and tablet computers 10 allow instant communication, the person in the field can easily communicate with the service person which might simplify the complete maintenance process. The smartphone or tablet computer 10 would be used for scanning, communicating and triggering the event E for the further processing. This would make dedicated maintenance first mobile devices 10 redundant.

A further application can also include a better damage write-up. In addition to the scanning of the aircraft engine component information I, the scanning can provide full details on component physical dimensions and its damage assessment. This allows a correlation of the actual damage details and a scaling against known component dimensions. Therefore, remote damage assessment can be done purely based on in-service data (e.g. pictures taken) taken in the field. This can also be used for technician based on-site, capturing and supplying of damage details. The same set up of the first mobile device 10 can accessed in a shop floor/maintenance/repair facility environment.

Since the maintenance method extends to a mechanic in the field with her/his first mobile device 10, it is possible to provide up-to-date information about installation and/or removal times of the engine component 1. This information can be important for scheduling the work in workshops. Due to the integration of the maintenance to the mechanic the actually needed installation and/or removal times can be gathered in the field by scanning the engine component 1 at the beginning of the maintenance job and at the end. If such data is gathered centrally, more accurate aircraft engine maintenance data can be developed over time. If the maintenance time in a particular instance is too long or too short, the reasons for the deviation might be important to evaluate. The scanning of the installed engine component 1 can also be used as personalized maintenance record.

Since a smartphone 10 or a tablet computer 10 provides a high quality display, a mechanic working on the aircraft engine 100 can see text and/or images assisting her/him to remove the engine component 1 from the engine 100 or to put it back into the engine 100.

If the first mobile device 10 comprises a GPS unit 12, the geographical location of the first mobile device 10 can be determined automatically. This information can be a part of the event E (i.e. the dataset associated with the event E) so that the central computer system 30 automatically knows from which location the request was made and to which location a delivery of the engine component 1 should be made. For this purpose the central computer system 30 has a database which matches geographical locations, e.g. to workshops or airports in the vicinity to the location data received from the GPS unit 12. With this location information the central computer system 30 can optimize the logistics in the delivery of the engine component. The objective function can be e.g. the fastest delivery time or the lowest cost. If e.g. several suppliers or storages stock the requested engine component 1, the central computer system 30 can automatically select the supplier or storage from which fastest delivery can be made. With the availability of different supply routes this does not necessarily have to be the closest supplier or storage. One further application could be that the central computer system 30 automatically determines the delivery of the engine component 1 with the smallest carbon footprint.

Having this information, the central computer system 30 can also feed information to a billing system 32 which is coupled with the central computer system 30. The billing information can be made available to the person using the first mobile device 10, the owner of the engine 100 and/or the engine manufacturer in an efficient way. As mentioned above, since individual parts and their history are known to the central computer system 30, the warranty status and its associated cost can be automatically taken into account and updated. Integrating the billing further leads to a reduction in the reporting generated. Since the method and the system is fully integrated electronically, it can be managed in a paperless way.

This allows an effective cost management, including the automated generation of penalties on suppliers when not meeting contractual requirements, e.g. as soon as removed components do not meet contracted MTBUR (Mean time between unit replacement) rates.

The maintenance information M is also valuable for an engine fleet management and an engine health monitoring system 31 coupled to the central computer 30. If information about engine component 1 replacements are logged over some time and over a whole fleet of engines 100 statistical analysis of single engines 100 or the whole fleet of engines 100 becomes possible. One consequence of this is that the supply chain can be managed more efficiently, e.g. reducing the stockpile of the engine components 1 or concentrating the stockpile in a geographic region where the demand is expected to be higher.

The integration of engine health data and the associated predictions into the system helps in on-time delivery of engine components 1.

If one particular engine 100 has a statistically significant different maintenance pattern than the rest of the engine fleet, it might be possible to pin-point the reasons for this behavior. It is also possible that a particular engine component 1 might significantly prone to replacements. The information automatically gathered by the data processing system allows to analyze data which is inaccessible without it.

A further aspect of an embodiment is a link to an electronic logbook 50 of the engine 100 or the aircraft associated with the engine 100. If e.g. a particular engine component 1 is changed in the aircraft engine 100 all the necessary information about the removed engine component 1 and the replacement engine component 1 are automatically entered into the logbook 50. Manipulations would be difficult or impossible because there is closed and consistent data flow between the request initiated from the first mobile device 10, the delivery of the engine component 1 and the replacement of the engine component 1 which is e.g. finalized by scanning the new part 1. All this information is logged in the electronic logbook 50. In the embodiment shown in FIG. 2, the relevant data can be supplied by the central computer system 30 and/or the computer system 20 coupled to the first mobile device 10. Alternatively or in addition the logbook 50 can be e.g. stored in a cloud system.

With the integration of engine health monitoring, intelligent diagnostic capability, failure messages recorded by aircraft and the autogeneration of parts requirements by aircraft becomes possible. A given failure message will dictate when a given aircraft engine component 1 will have to be replaced and ordered without the intervention of humans

In FIG. 2 a further embodiment is described which enhance the accountability and the safety of the system. Here the engine component information I which is read from the information carrier 2 comprises code data C which can only be processed by specifically enabled first mobile devices 10, e.g. by an app with which can decrypt some encrypted data in the code data C. For this purpose the first mobile device 10 comprises a decoding unit 13.

It is understood that the features described in connection with FIG. 2 do not have to be present in each and every embodiment. It is possible to use any subset and combination of the features described herein.

In the embodiments described above the communication between the first mobile device 10, the computer system 20 and the central computer system 30 can be done via wireless data transfer channels, such as Wi-Fi and/or phone connections. The communication can take place over the Internet and make use of one or more cloud computing systems. It is not required but possible that the central computer system 30 is one dedicated machine. It is possible that the central computer system 30 is a distributed computer system making e.g. use of cloud data processing and storage.

The data input and/or output on a smartphone 10 or a tablet computer 10 can take place through apps installed on the first mobile device 10. By communication through apps, it is no longer necessary to distribute dedicate software for taking component orders or to maintain portals for taking component orders.

In FIG. 3, the embodiment described in FIG. 1 is modified in that sense that the computer system 20 is integrated with the first mobile device 10. Since e.g. smartphones 10 become increasingly more powerful data processing devices, the generation of the event E and the generation of the information token I would take place within the first mobile device 10. Such a system and method could be used in connection with one or more of the features described in FIG. 2.

The ergonomics of being able to scan an engine component 1 with a first mobile device 10 and be presented with all of the pertinent data at the press of a button means that the customer is having to spend less time on all routine activities such as administration tasks, reporting tasks, spares ordering, quality regulations, manual consultation etc. The improved ergonomics and the resulting overall time savings will lead to less time needed to service and/or maintain aircraft engines 100. The added benefit is that the customer gets a much more pleasant service experience. Furthermore, the ability to use “real time” data and using it to control/steer/adjust can be regarded as a strategic enabler.

The automation possible through the usage of e.g. QR/Data Matrix scanning technology allows the organization to manage all of its activities more lean and requires less energy to support routine activities. A further aspect is the fact that embodiments of the system and the methods will allow the manufacturers to rapidly grow its footprint globally—i.e. easier to contract and/or team up with other external parties as the data connection between all involved parties will take place via software on the first mobile devices 10 (e.g. through supplied apps) and in particular the already existing smartphones 10 or tablet computers 10 owned by the various external parties.

The methods and system described above allow an integrated supply chain extending even to an individual mechanic working on the engine. Since working on aircraft engines 100 involves numerous personal qualification levels (e.g. licensed mechanics); it is easier to check on the correctness of the maintenance quality on every level. If e.g. a mechanic has completed the maintenance job, that job would be associated with her/his ID when scanning the built-in engine component 1 with her/his first mobile device 10, in particular the smartphone 10. Again, using a smartphone 10 allows an efficient and personalized maintenance. Through the same system it is also possible to effectively give the supplier of the engine component 1 a feedback about the service. This information is valuable to be integrated in all the other data gathered in the business triggered by the event E.

The embodiments can also be used in the maintenance of other engine systems than an aircraft engine 100.

One possible applications are nuclear engines 100 which require stringent and regulated maintenance. In e.g. a nuclear submarine engine, the same principles would be applicable as mentioned in connection with the aircraft engine 100. In this context a regulatory system 33 would be coupled to the central computer system 30. This regulatory 33 would comprise data about required or recommended maintenance tasks together with their required timings. So if one maintenance task in a particular area is undertaken, the upcoming maintenance tasks stipulated by the regulatory rules could be recommended.

The same tasks as mentioned above would also apply e.g. to wind power engines and naval engine systems.

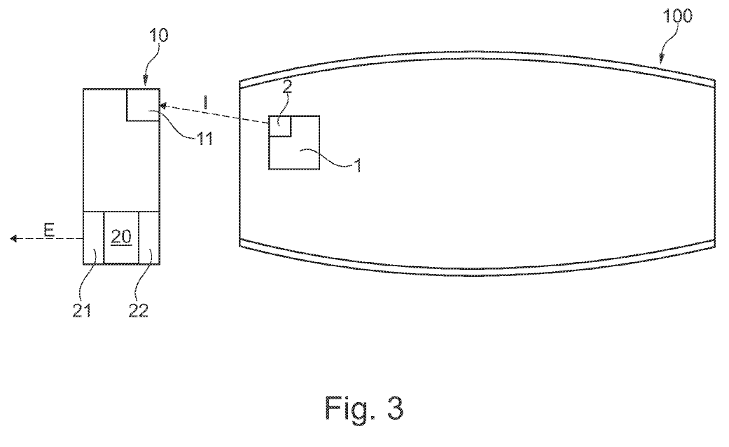

In FIG. 4 an abstracted top level view of an embodiment of the method or the system is given. A first mobile device 10 and a computer system 20 (i.e. a server) are connected through a network 36, here the internet. In reality there will be a plurality of first mobile devices 10 and a plurality of computer systems 20, all connected through a network 36. The network 36 can comprise wireless and wire-based components. Through the network 36 a cloud server 37 can be accessed from the first mobile device 10 and/or computer system 20. On the cloud server 37 a database with patterns of prestored images of information carrier 2 is stored.

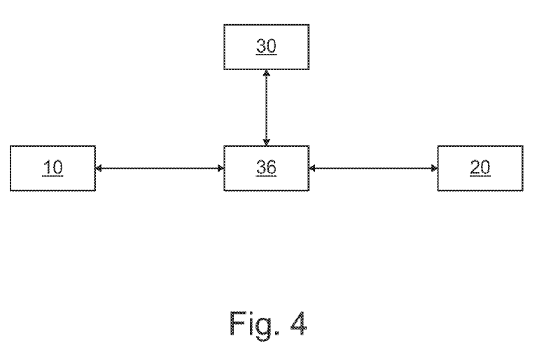

In FIG. 5 an embodiment is shown which uses the database of prestored images of information carriers 2. Starting point is an engine component with an information carrier 2 comprising a pattern (step 501) such as e.g. a QR-code. It should be noted that a patterned information carrier 2 has two aspects.

The first aspect is some encoded information in the pattern e.g. a part number which is decoded to turn the pixel pattern into readable or legible information. The second aspect is that the information carrier 2 with a pattern can also be useful as a pattern itself. That means that the encoded information is not decoded but the pattern is processed as a pattern itself. This is here termed as scan-pattern.

In the method shown in FIG. 5 the scanner device 11 of the first mobile device 10 (step 502) is used to take an image of the pattern of the information carrier 2 (step 503). The first mobile device 10 compares the resulting scan-pattern with the prestored patterns in the cloud server 37 (step 504). When a matching pattern is found, the first mobile device 10 can confirm the information encoded in the information carrier 2, such as e.g. a part number, a serial number, a batch number and/or a manufacturing number (step 505).

Based on this information the system can now provide some services using the embodiments described above (step 506).

Here the information carrier 2, in particular a QR-Code, a DataMatrix-Code or a barcode is scanned as a scan-pattern. The scan-pattern is then compared by a pattern-matching method with prestored patterns in a database, in particular a database stored in the cloud server 37, the pattern-matching method being executed on the computer system 20.

Three different possibilities are shown in FIG. 5. In a first embodiment, the system can deduce that the person with the first mobile device 10 needs to know how to remove a certain part from the aircraft engine (step 507). Based on that information, relevant technical information is obtained from the cloud server 37 (step 508).

In a second embodiment the request is related to the availability of a certain aircraft engine component 1 (step 509). As a result the stock data is obtained from the cloud server 37 (step 510).

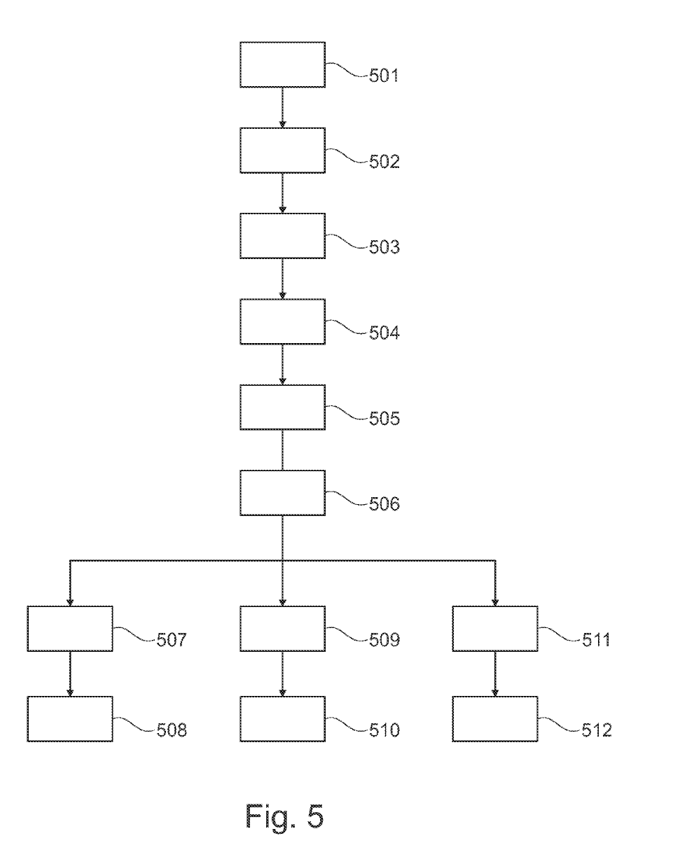

In a third embodiment the request is related to returning an aircraft engine component 1 (step 511). Again the required information is obtained from the cloud server 37 (step 512). This embodiment is further described in FIG. 6.

The aim is here to generate a return label for a broken aircraft component 1. After identifying the scan-pattern with the help of the database in the cloud server 37, the part number, the serial number and the batch manufacturing number are known (step 601). Then the computer system 20 generates automatically the return label with an unique reference tag on the return label (e.g. an QR code) (step 602). Then the computer system 20 automatically generates a pick-up order (step 603), i.e. an event E, with a logistic company (step 604), including e.g. the pick-up location, the weight of the package and the destination. The computer system then also generates an entry event within the cloud server 37 (step 605).

From the logistics company information about the transport progress is collected and processed by the computer system 20 (step 606). This step also includes the generation of an information token T which is sent to the first mobile device 10, in dependence of the event E.

In all those embodiments the pattern-matching method can comprises a machine-leaning component and/or processing means for location information of the first mobile device 10 for speeding-up the pattern-matching. If the pattern-matching method has information about the location of the first mobile device 10 or even about the engine in question, the search domain can be considerably narrowed, making the search for the scan-pattern in the database more efficient.

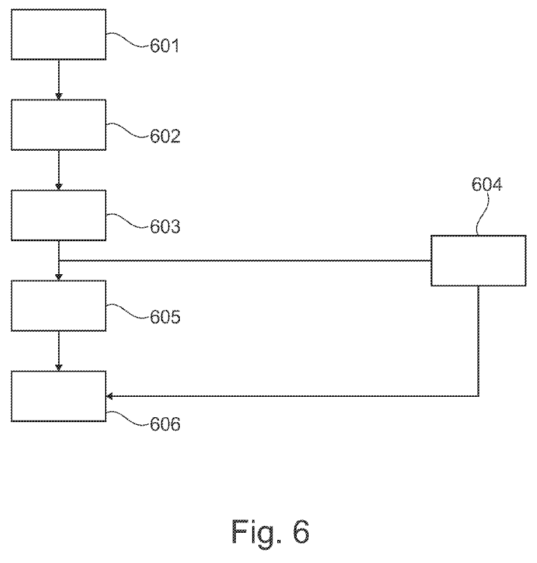

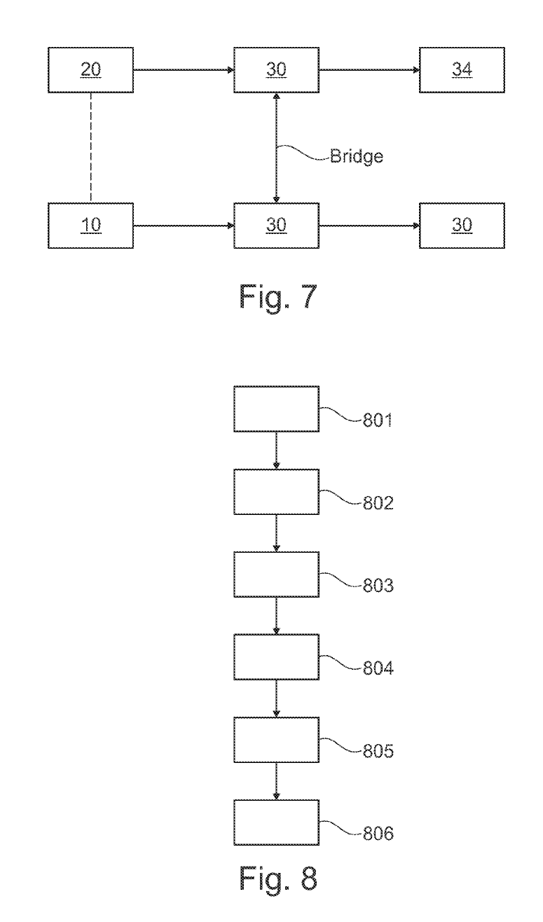

In FIGS. 7 and 8 details about a logistic app on a second mobile device 20 are given which collaborates with the computer system 20 associated with the first mobile device 10.

In FIG. 7 the computer system 20 associated with the first mobile device 10 communicates with the second mobile device 20 via a telephone connection. The communication can also take place via the internet using an exchange bridge to the logistics company. Ultimately both mobile devices 10, 20 also communicate with their respective central computers 30, 34. In principle other communication routes are possible.

In FIG. 8 the functionality of the app on the second mobile device 20, i.e. the logistic app is described. The second mobile device 20 scans in step 801 the return label which was generated using the first mobile device 10 (see e.g. FIG. 6). The code on the return label is processed (e.g. decoded, pattern-matched) to display all relevant shipping details, e.g. shipment address, weight, dimensions and material codes. Whenever more information becomes available as it is entered in the system (e.g. pick-up time, handing-over details, final delivery details) the logistics server 34 is provided with status updates (step 803) which in turn can be distributed to the other unites in the net. The logistics servers 37 provides the computer system 30 with updates regarding the status, e.g. via the above-mentioned exchange bridge (step 804) and eventually the first mobile device 10 (step 805).

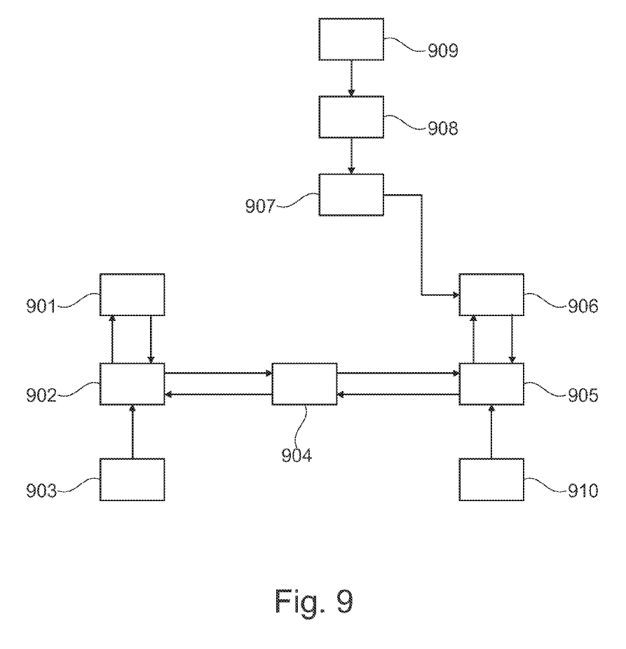

In FIG. 9 the communication between two apps (via wireless Internet) is shown. One app is running on the mobile device of the logistics provider (901) and one app is running on the mobile device of an end user (906).

The mobile device of the logistic provider (901) is in bidirectional communication with the cloud database of the logistic provider (902). The logistic server is maintaining (903) the logistic cloud database (902).

The bidirectional communication of logistic provider cloud database (902) the with the end user (906) takes place via the Exchange bridge (904). The Exchange bridge (904) is bidirectionally connected with the customer's cloud database (905), which is maintained by the customer's server (910).

The end user's mobile device (906) is bidirectionally in communication with the cloud database (905) of the customer. End user mobile device (906) takes input from a scanner (907) which reads in e.g. an engine component data (908), e.g. from a data matrix or QR code (909).

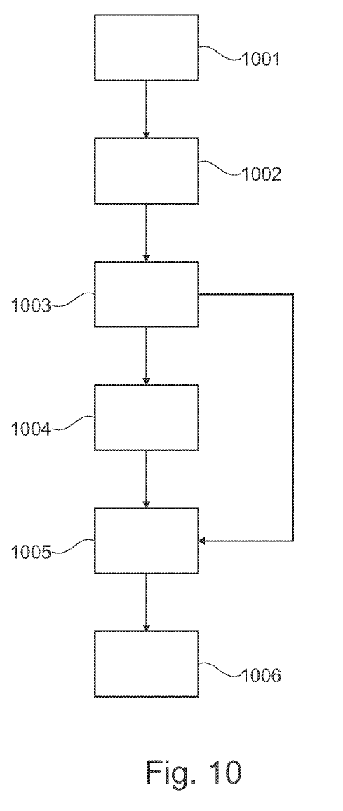

In FIG. 10 an embodiment involving the pattern recognition method is described. At the initial instance, the scanner will decode the bar code, data matrix or QR code. If this is however not possible due to the label being damage, not fully readable due to surface corrosion build up, the scanner will use its pattern recognition technique so that it is still able to identify the “scanned ” part. In this context it important to note that reference pictures held in the cloud data base are actually only pictures of the bar code/data matrix and/or QR code as imprinted on the components. The pictures held in the cloud are not of the entire component as such.

Starting point in the embodiment shown in FIG. 10 is an engine component information e.g. in the form of a data matrix (1001). The scanner of the first mobile device scans (1002) this data matrix. If the decoding of the data matrix fails (1003), the pattern-matching method is automatically invoked (1004).

It is also possible to uses the pattern-matching method parallel (i.e. concurrently) to the decoding of the information carrier for additional safety.

In any case the information in the information carrier 2 is obtained, e.g. the details of the engine component (part number, serial number, batch/manufacturing number etc.) (1005) are determined.

Then the app will provide a selection of options (1006), depending on the information obtained from the information carrier 2. This could be e.g. information of how to remove and/or install an engine component involving technical documentation accessed from the cloud server. This could also be information about the availability of the engine component, with an SAP stock holding information obtained from the cloud server.

The method, system devices and products are also intended to cover an engine, engine assembly or portion of an engine, nacelle, EBU, airframe components and/or any components of an aircraft or vehicle.

Further, it has been found that when testing various platforms to see if it could be ensured that the demanded data volumes on any given part could be retrieved or uploaded quickly enough, an approach has been determined to greatly aid this. Once the actual record of the component is created in the cloud via the app, the “build record” on each component is given a unique URL (link). This ensures that the data can be retrieved and uploaded quickly and smoothly without the end user of the app noticing the slightly longer time the platform needs to process the data, which is all relatively speaking. The end user of apps can be very demanding and it is desirable that data be displayed back to the end users in 5 to 10 milliseconds. When handling large volumes of data transfer, it might take a fraction longer and for this reason, working with unique allocated URL links can overcome the response speed challenge.

Different embodiments are described above in connection with engine systems, in particular for an aircraft. The same principles are also applicable for vehicle systems, such as cars. Here as well, the maintenance can be enhance by using the embodiments described above. Furthermore, all embodiments are also applicable in the supply chain management in manufacturing.

### LIST OF REFERENCE NUMBERS

1 aircraft engine component, engine component, vehicle component
2 information carrier, QR-Code
10 first mobile device, smartphone, tablet computer
11 scanner device
12 GPS unit
13 decoding unit
15 second mobile device
20 computer system
21 event generating unit
22 information generating unit
30 central computer system
31 fleet management and/or engine health monitoring system
32 billing system
33 regulatory system
34 logistics server
35 wireless network
36 internet
37 cloud server
40 printer
41 transport label
50 logbook of aircraft/aircraft engine
100 aircraft engine, engine system
A availability and/or tracking data
C control data
E event
I engine component information, vehicle component information
M maintenance data
T information token

1. A method for automatic data processing in engine systems maintenance or manufacturing, in particular aircraft engine maintenance, or vehicle maintenance or manufacturing comprising
a) scanning engine component information or vehicle component information from an information carrier coupled to an engine component or a vehicle component or associated with the engine component or the vehicle component with an image scanner device of a first mobile device, in particular a smartphone or a tablet computer,
b) the information carrier, in particular a QR-Code, a DataMatrix-Code or a barcode comprises a pattern which is scanned as a scan-pattern, the scan-pattern is then compared by a pattern-matching method with prestored patterns in a database, in particular a database stored in a cloud server, the pattern-matching method being executed on the computer system and
c) processing the engine component information or the vehicle component information in a computer system connected at least intermittently with the first mobile device and/or in a computer system integrated with the first mobile device, the first mobile device communicating with a central computer system through a wireless network in particular the internet.

2. A method for automatic data processing in engine systems maintenance or manufacturing, in particular aircraft engine maintenance, or vehicle maintenance or manufacturing comprising
a) scanning engine component information or vehicle component information from an information carrier coupled to an engine component or vehicle component with an image scanner device of a first mobile device, in particular a smartphone or a tablet computer,
b) processing the engine component information or vehicle component information in a computer system connected at least intermittently with the first mobile device and/or in a computer system integrated with the first mobile device,
c) automatically generating at least one event in dependence of the engine component information or vehicle component information, in particular at least one order event for the engine component or vehicle component and
d) the computer system automatically sending at least one an information token to the first mobile device in dependence of the generation of the at least one event, in particular at least one confirmation token of the at least one order event.

3. The method according to claim 1, with an automatic generation of at least one event in dependence of the engine component information or vehicle component, in particular at least one order event for the engine component or vehicle component.

4. The method according to claim 1, with an automatic generation of at least one event in dependence of the engine component information or vehicle component, in particular at least one order event for the engine component or vehicle component, wherein upon receiving the at least one event the central computer system checks the availability of the engine component or vehicle component and automatically sends availability and/or tracking data to the computer system and/or the first mobile device.

5. The method according to claim 1, wherein the central computer system automatically sends maintenance data to the computer system and/or the first mobile device, in particular about at least one engine component or vehicle component depending on the engine component information or vehicle component information which might require replacement within a predetermined time period.

6. The method according to claim 1, with an automatic generation of at least one event in dependence of the engine component information or vehicle component, in particular at least one order event for the engine component or vehicle component, wherein upon receiving the at least one event the central computer system checks the availability of the engine component or vehicle component and automatically sends availability and/or tracking data to the computer system and/or the first mobile device, and wherein the availability and/or tracking data and/or the maintenance data is automatically generated and/or provided in dependence of the geographic location of the first mobile device.

7. The method according to claim 1, wherein the information related to the at least one event is automatically forwarded to a fleet management and/or engine health monitoring system, a vehicle health monitoring system, a component health monitoring system, a regulatory system, a billing system and/or is statistically processed in the central computer system.

8. The method according to claim 1, where in the information carrier comprises a two-dimensional code, in particular a QR-Code or DataMatrix-Code, a RFID-transponder and/or a barcode.

9. The method according to claim 1, wherein the at least one event automatically triggers the printing of a transport label for transporting the engine component or vehicle component to a predetermined location and/or automatically triggers a transport order of the engine component or vehicle component to a predetermined location, in particular in dependence of a cost and/or route optimizer.

10. The method according to claim 1, wherein the at least one event automatically triggers at least one process in the supply chain management for the engine component or vehicle component and/or a statistical analysis, in particular by combining the scanned engine component information or vehicle component with other technical and/or commercial data available in the central computer system, more in particular by gathering the technical and/or commercial data at least in part through the scanning of the engine component data vehicle component data.

11. The method according to claim 1, wherein the at least one event automatically triggers an entry in a logbook of the engine, in particular an aircraft and/or the aircraft engine, in particular with details about a defective engine component and/or a replaced engine component.

12. The method according to claim 1, wherein the engine component information is associated with code data which can only be processed by an authorized scanner device and/or first mobile device.

13. The method according to claim 1, wherein the engine component information is associated with a 3D-printing dataset and the generated at least one event automatically triggers a 3D-printing process.

14. The method according to claim 1, wherein the engine system comprises a stationary gas turbine, a combustion engine, in particular a diesel engine of a ship or a locomotive, a wind power engine, a nuclear engine, in particular in a nuclear submarine, naval machinery, in particular anchor winches or cranes, or naval transmission systems, in particular propellers, propulsion systems and bow thrusters or the vehicle system comprises a car, a train or an airplane.

15. The method according to claim 1, wherein at least on first mobile device and at least one second mobile device, the at least one second mobile device being coupled to a logistic person or process communicate via a wireless network, in particular comprising the internet.

16. The method according to claim 1, wherein the pattern-matching method comprises a machine-leaning component and/or processing means for location information of the first mobile device for speeding-up the pattern-matching.

17. The method according to claim 1, wherein the pattern-matching method is used, in particularly automatically after a decoding of the information carrier is not successful.

18. The method according to claim 1, wherein the pattern-matching method and the decoding of the information carrier are executed concurrently.

19. The method according to claim 1, wherein the information carrier taken from a photo.

20. The method according to claim 1, wherein the central computer system being connected to the network of the first mobile device through a http Listener continuously searching the network for messages sent by the first mobile device and/or the computer system automatically sending at least one an information token to the first mobile device in dependence of the generation of the at least one event, in particular at least one confirmation token of the at least one order event.

21. A data processing system for engine maintenance or manufacturing data, in particular aircraft engine maintenance, or vehicle maintenance or manufacturing data, comprising
a) a first mobile device, in particular a smartphone or a tablet computer, with a scanner device for scanning engine component information or vehicle component information from an information carrier coupled to an engine component or vehicle component or associated with the engine component or vehicle component, with the information carrier, in particular a QR-Code, a DataMatrix-Code or a barcode comprises a pattern which is scannable as a scan-pattern by a scanner, the scan-pattern is comparable by a pattern-matching method with prestored patterns in a database, in particular a database stored in a cloud server, the pattern-matching method being executed on the computer system,
b) a computer system for processing the engine component information or vehicle component information, the computer system connectable at least intermittently with the first mobile device and/or integrated with the first mobile device, the first mobile device communicating with a central computer system through a wireless network, in particular comprising the internet.

22. The data processing system according to claim 21, with an information token generation unit for generating at least one information token about the at least one event to be sent to the first mobile device, in particular as a confirmation of the at least one order event and/or an event generation unit for automatically generating at least one event, in particular at least one order event for the engine component or vehicle component in dependence of the processing of the engine component information or the vehicle component information.

23. A data processing system for engine maintenance or manufacturing data, in particular aircraft engine maintenance or vehicle maintenance or manufacturing data, comprising
a) a first mobile device, in particular a smartphone or a tablet computer, with a scanner device for scanning engine component information or vehicle component information from an information carrier coupled to an engine component or a vehicle component,
b) a computer system for processing the engine component information or vehicle component information, the computer system connectable at least intermittently with the first mobile device and/or integrated with the first mobile device,
c) an event generation unit for automatically generating at least one event, in particular at least one order event for the engine component or vehicle component in dependence of the processing of the engine component information or vehicle component information and
d) an information token generation unit for generating at least one information token about the at least one event to be sent to the mobile device, in particular as a confirmation of the at least one order event.

24. The data processing system according to claim 21, wherein the first mobile device comprises a GPS unit for geographically locating the first mobile device.

25. The data processing system according to claim 21, wherein the central computer system is coupled with a database handling maintenance data, a fleet management, engine health monitoring system, a vehicle health monitoring system, a billing system and/or a database for statistically processing data related to events.

26. The data processing system according to 21, wherein the scanner device and/or first mobile device comprise a decoding unit to decode code data associated with the engine component information or the vehicle component information.

27. The data processing system according to claim 21, wherein the central computer system is connected to the network of the first mobile device through a http Listener continuously searching the network for messages sent by the first mobile device.

28. A mobile device designed specifically to be used in the method of claim 1.

29. The mobile device according to claim 28, in particular a smartphone or a tablet computer, with a scanner device for scanning engine component information or vehicle component information from an information carrier coupled to an engine component or vehicle component or associated with the engine component or vehicle component, with the information carrier, in particular a QR-Code, a DataMatrix-Code or a barcode comprises a pattern which is scannable as a scan-pattern by a scanner device, in particular the scanner device, the scan-pattern is comparable by a pattern-matching method with prestored patterns in a database, in particular a database stored in a cloud server, the pattern-matching method being executed on the computer system and means for communicating with a computer system for processing the engine component information or vehicle component information, the computer system connectable at least intermittently with the first mobile device and/or integrated with the first mobile device, the first mobile device communicating with a central computer system through a wireless network, in particular comprising the internet.

30. The mobile device according to claim 28, in particular a smartphone or a tablet computer, with a scanner device for scanning engine component information or vehicle component information from an information carrier coupled to an engine component or a vehicle component, with means for communication with a computer system for processing the engine component information or vehicle component information, the computer system connectable at least intermittently with the first mobile device and/or integrated with the first mobile device and an event generation unit for automatically generating at least one event, in particular at least one order event for the engine component or vehicle component in dependence of the processing of the engine component information or vehicle component information and an information token generation unit for generating at least one information token about the at least one event to be sent to the mobile device, in particular as a confirmation of the at least one order event.

31. A software product storable and operable a first mobile device, in particular a mobile device according to claim 28, which in operation performs the following steps for an automatic data processing in engine systems maintenance or manufacturing, in particular aircraft engine maintenance, or vehicle maintenance or manufacturing:
a) scanning engine component information or vehicle component information from an information carrier coupled to an engine component or a vehicle component or associated with the engine component or the vehicle component with an image scanner device of the first mobile device, in particular a smartphone or a tablet computer,
b) the information carrier, in particular a QR-Code, a DataMatrix-Code or a barcode comprising a pattern which is scanned as a scan-pattern, the scan-pattern is then compared by a pattern-matching method with prestored patterns in a database, in particular a database stored in a cloud server, the pattern-matching method being executed on the computer system and
c) processing the engine component information or the vehicle component information in a computer system connected at least intermittently with the first mobile device and/or in a computer system integrated with the first mobile device, the first mobile device communicating with a central computer system through a wireless network in particular the internet.

32. A software product storable and operable a first mobile device, in particular a mobile device according to claim 28, which in operation performs the following steps for an automatic data processing in engine systems maintenance or manufacturing, in particular aircraft engine maintenance, or vehicle maintenance or manufacturing:
a) scanning engine component information or vehicle component information from an information carrier coupled to an engine component or a vehicle component with a scanner device of the first mobile device, in particular a smart phone or a tablet computer.
b) processing the engine component information or vehicle component information, with a computer system connectable at least intermittently with the first mobile device and/or integrated with the first mobile device,
c) automatically processing or generating at least one event with an event generation unit, in particular at least one order event for the engine component or vehicle component in dependence of the processing of the engine component information or vehicle component information and
d) processing or generating at least one information token with an information token generation unit about the at least one event to be sent to the mobile device, in particular as a confirmation of the at least one order event.

33. The method according to claim 2, with an automatic generation of at least one event in dependence of the engine component information or vehicle component, in particular at least one order event for the engine component or vehicle component.

34. The method according to claim 2, with an automatic generation of at least one event in dependence of the engine component information or vehicle component, in particular at least one order event for the engine component or vehicle component, wherein upon receiving the at least one event the central computer system checks the availability of the engine component or vehicle component and automatically sends availability and/or tracking data to the computer system and/or the first mobile device.

35. The method according to claim 2, wherein the central computer system automatically sends maintenance data to the computer system and/or the first mobile device, in particular about at least one engine component or vehicle component depending on the engine component information or vehicle component information which might require replacement within a predetermined time period.

36. The method according to claim 2, with an automatic generation of at least one event in dependence of the engine component information or vehicle component, in particular at least one order event for the engine component or vehicle component, wherein upon receiving the at least one event the central computer system checks the availability of the engine component or vehicle component and automatically sends availability and/or tracking data to the computer system and/or the first mobile device, and wherein the availability and/or tracking data and/or the maintenance data is automatically generated and/or provided in dependence of the geographic location of the first mobile device.

37. The method according to claim 2, wherein the information related to the at least one event is automatically forwarded to a fleet management and/or engine health monitoring system, a vehicle health monitoring system, a component health monitoring system, a regulatory system, a billing system and/or is statistically processed in the central computer system.

38. The method according to claim 2, where in the information carrier comprises a two-dimensional code, in particular a QR-Code or DataMatrix-Code, a RFID-transponder and/or a barcode.

39. The method according to claim 2, wherein the at least one event automatically triggers the printing of a transport label for transporting the engine component or vehicle component to a predetermined location and/or automatically triggers a transport order of the engine component or vehicle component to a predetermined location, in particular in dependence of a cost and/or route optimizer.

40. The method according to claim 2, wherein the at least one event automatically triggers at least one process in the supply chain management for the engine component or vehicle component and/or a statistical analysis, in particular by combining the scanned engine component information or vehicle component with other technical and/or commercial data available in the central computer system, more in particular by gathering the technical and/or commercial data at least in part through the scanning of the engine component data or vehicle component data.

41. The method according to claim 2, wherein the at least one event automatically triggers an entry in a logbook of the engine, in particular an aircraft and/or the aircraft engine, in particular with details about a defective engine component and/or a replaced engine component.

42. The method according to claim 2, wherein the engine component information is associated with code data which can only be processed by an authorized scanner device and/or first mobile device.

43. The method according to claim 2, wherein the engine component information is associated with a 3D-printing dataset and the generated at least one event automatically triggers a 3D-printing process.

44. The method according to claim 2, wherein the engine system comprises a stationary gas turbine, a combustion engine, in particular a diesel engine of a ship or a locomotive, a wind power engine, a nuclear engine, in particular in a nuclear submarine, naval machinery, in particular anchor winches or cranes, or naval transmission systems, in particular propellers, propulsion systems and bow thrusters or the vehicle system comprises a car, a train or an airplane.

45. The method according to claim 2, wherein at least on first mobile device and at least one second mobile device, the at least one second mobile device being coupled to a logistic person or process communicate via a wireless network, in particular comprising the internet.

46. The method according to claim 2, wherein the pattern-matching method comprises a machine-leaning component and/or processing means for location information of the first mobile device for speeding-up the pattern-matching.

47. The method according to claim 2, wherein the pattern-matching method is used, in particularly automatically after a decoding of the information carrier is not successful.

48. The method according to claim 2, wherein the pattern-matching method and the decoding of the information carrier are executed concurrently.

49. The method according to claim 2, wherein the information carrier taken from a photo.

50. The method according to claim 2, wherein the central computer system being connected to the network of the first mobile device through a http Listener continuously searching the network for messages sent by the first mobile device and/or the computer system automatically sending at least one an information token to the first mobile device in dependence of the generation of the at least one event, in particular at least one confirmation token of the at least one order event.

51. The data processing system according to claim 23, wherein the first mobile device comprises a GPS unit for geographically locating the first mobile device.

52. The data processing system according to claim 23, wherein the central computer system is coupled with a database handling maintenance data, a fleet management, engine health monitoring system, a vehicle health monitoring system, a billing system and/or a database for statistically processing data related to events.

53. The data processing system according to 23, wherein the scanner device and/or first mobile device comprise a decoding unit to decode code data associated with the engine component information or the vehicle component information.

54. The data processing system according to claim 23, wherein the central computer system is connected to the network of the first mobile device through a http Listener continuously searching the network for messages sent by the first mobile device.

55. A mobile device designed specifically to be used in the method of claim 2.
